(19) United States
(12) Patent Application Publication
(10) Pub. No.: US 2024/0198824 A1
(43) Pub. Date: Jun. 20, 2024

(54) CHARGING CIRCUIT FOR AN ENERGY STORAGE DEVICE OF A VEHICLE

(71) Applicant: BorgWarner Sweden AB, Landskrona (SE)

(72) Inventors: Hans AULIN, Lomma (SE); Gabriel DOMINGUES, Lund (SE); Wolfgang WENZEL, Stuttgart (SE)

(21) Appl. No.: 18/556,771

(22) PCT Filed: May 25, 2022
(86) PCT No.: PCT/EP2022/060938

§ 371 Date: Oct. 23, 2023

(30) Foreign Application Priority Data
Apr. 26, 2021 (SE) 2150528-4

(51) Int. Cl. B60L 53/22; B60L 53/53

(52) U.S. Cl. CPC B60L 53/22; B60L 53/53; B60L 2210/14; B60L 2210/30; B60L 2240/527; B60L 2240/547

(57) ABSTRACT

A charging circuit and a charging system to charge a battery of an electric vehicle. The charging circuit includes an AC/DC-inverter and an AC electrical machine system, that can selectively be run as a voltage boost converter or an electric drive system. In the charging circuit, a DC input voltage can, after passing a switching element but before entering the AC electrical machine system, be diverted via a selective electronic gate to reach an output port of the charging circuit in a conducting direction of the gate. At the same time, any backflow of current to an input port of the charging circuit is prevented in a reverse direction of the gate.

### TECHNICAL FIELD

The present invention relates to a charging circuit for an energy storage device, to a charging system, and to a method for operating such charging systems.

### BACKGROUND

As electrically driven vehicles are of increasing relevance in the global market, charging technology for such vehicles has become a major development aspect. Due to the quite early market stage and ongoing development, technical interface and compatibility problems still have to be solved. For example, some of the established charging equipment is designed to operate with vehicles having a nominal battery charging voltage at a lower level, for example at 400V. At the same time, newer vehicles tend to have a nominal battery charging voltage at a higher level, for example at 800V. Thus is occurs that the higher level requirement of some vehicles exceeds the capabilities of existing charging equipment, such as charging stations. Consequently, the vehicle requires a higher output voltage from the charging equipment than the equipment is designed to produce in such cases.

One suggested technical solution is disclosed by the patent document US 2020/0361323 A1. Therein, a charging system is described, making use of an electric drive and an inverter of a vehicle by operating these components as a boost converter. Thus, a DC input voltage of 400 V is increased and supplied to the battery of the vehicle as an increased DC input voltage at 800 V.

However, the presented solution features a high number of mechanically actuated parts to control the system, such as relays. This significantly enhances the technical complexity to control the system and thereby also the costs. Further, the mechanical components are exposed to high frictional effects, ending up in noise development and a lower product durability.

In view of the above-mentioned example of the prior art, an improved charging system is required.

### SUMMARY

Accordingly, the objective underlying the invention disclosed herein is to eliminate the deficiencies of the prior art. It aims at providing an improved technical solution to charge an energy storage device in a robust and easy controllable manner and at low costs. Further, it is an objective of the invention to provide a technical solution to charge the energy storage device at different charging voltages.

This objective is achieved by the technical subject matter of the independent claims 1, 9, 12 and 13. Preferred embodiments of the invention can be gained from the dependent claims and the following description.

A first aspect of the invention refers to a charging circuit for an energy storage device, comprising:
an input port, designed to receive a DC input voltage from an external charging device;
an output port, electrically connectable to an energy storage device;
an AC/DC-inverter, electrically connected to the output port;
an AC electrical machine system, comprising a neutral side being electrically connected to the input port via a switching element, so that the DC input voltage can be selectively supplied to the neutral side, further comprising a phase side being electrically connected to the AC/DC-inverter;
a controller, at least configured to selectively operate the AC/DC-inverter and the AC electrical machine system as a voltage boost converter to increase the DC input voltage and supply it to the output port, or as an electric drive system to convert and supply a drive voltage of the energy storage device from the output port to the AC electrical machine system, or to interrupt the electrical connection between the input port and output port via the AC electrical machine system and AC/DC-inverter.

According to the invention, a DC input voltage bypass is provided, running from between the neutral side and the switching element via a selective electronic gate to the output port, said gate having a least one operational state with a conducting direction towards the output port and a reverse, non-conducting direction towards the input port.

In other words, the bypass of the charging circuit of the invention is designed to conduct the DC input voltage from a point behind the switching element or directly from an output side of the switching element to the output port, without traversing the AC electrical machine system. The selective electronic gate then allows the DC input voltage to reach the output port in the conducting direction. At the same time, any backflow of current to the input port is prevented in the reverse direction.

However, if the DC input voltage is increased via the AC electrical machine system and the AC/DC-inverter by operating these two as a voltage boost converter, the increased DC input voltage is applied to the output port via the AC/DC-inverter. As the DC input voltage bypass also reaches the output port, the increased DC input voltage applies to the selective electronic gate, as well, from the side of the output port. This means downstream the selective electronic gate, in the conducting direction, the DC input voltage bypass is at the same higher electrical potential as the output port. At the same time, the original DC input voltage applies to the selective electronic gate from the side of the input port. The original DC input voltage is provided at a lower level and is (per definition) lower than the increased DC input voltage that is increased to a higher level. This means upstream of the selective electronic gate, in the reverse direction, the DC input voltage bypass is at a lower electrical potential according to the original DC input voltage.

Therefore, automatically no current will flow through the selective electronic gate in the conducting direction from the input port to the output port, if the voltage boost converter is operated. At the same time, any flow of current from the output port to the input port via the selective electronic gate is prevented due to the reverse direction of the selective electronic gate. Likewise, any backflow if current from the output port to the input port via the AC/DC-inverter is avoided by internal components of the AC/DC-inverter, such as diodes that are normally present in AC/DC-inverters.

With this said, it is possible to simply switch between a supply of DC input voltage to the output port via the DC input voltage bypass and a supply of an increased DC input voltage to the output port via the AC electrical machine system and the AC/DC-inverter operated as a voltage boost converter. This can simply be done by operating these components as the voltage boost converter or not operating them in that way. If these are not operated as the voltage boost converter while the energy storage device is charged via the DC input voltage bypass, the electrical connection between the input port and output port should preferably be interrupted via the AC electrical machine system and AC/DC-inverter to avoid electrical loss.

To achieve the described switching function, no additional mechanically driven switches, such as relays, are required. It is even sufficient to provide the selective electronic gate with only one operational state, that means the conducting direction is static and always points towards the output port and the reverse direction always points towards the input port. Accordingly, there is no need to actively control such a selective electronic gate. At the same time, the required electrical safety is assured by the switching element between the input port and the selective electronic gate. The selective electronic gate can also have electronically switchable operational states. For example, it can be switched between a shut-off state, wherein no current is passed through at all and a state wherein the conducting direction points towards the output port and the reverse direction points towards the input port.

As the selective electronic gate operates electronically, it is not exposed to any mechanically abrasive effects. This leads to increased robustness and silence of the charging circuit of the invention. At the same time, the selective electronic gate can be controlled and integrated in the system at low effort and costs are decreased. As an overall benefit, costs of the charging circuit of the invention is decreased, whereas technical reliability and durability are increased.

In a preferred embodiment of the charging circuit of the invention, the DC input voltage bypass is bypassing the AC/DC-inverter.

This provides the advantage of robust and simple system integration.

In a preferred embodiment of the charging circuit of the invention, as an alternative to the previous embodiment, the DC input voltage bypass is running to the output port via the AC/DC-inverter, that is located electrically downstream the selective electronic gate in the conducting direction.

In other words, the DC input voltage bypass shares one or more electrical components with the AC/DC-inverter. Thus, the effort of integrating the bypass in the system and the number of additionally required components is reduced. From the function of the charging circuit of the invention described herein, it will be easily understood by a person skilled in the art, that the DC input voltage bypass preferably connects to a component of the AC/DC-inverter exposed to the increased DC input voltage, when the voltage boost converter is operated.

In a preferred embodiment of the charging circuit of the invention, the controller is configured to measure the DC input voltage or to receive a signal from the external charging device corresponding to the DC input voltage and, if the DC input voltage is at a pre-defined low level operate the voltage boost converter and, if the DC input voltage is at a pre-defined high level interrupt the electrical connection between the input port and output port via the AC electrical machine system and AC/DC-inverter.

The terms “pre-defined high level” und “pre-defined low level” imply the DC input voltage ranging below or above a pre-defined threshold or in a pre-defined low interval or pre-defined high interval defined by a plurality of respective thresholds. There can also be a number of thresholds or intervals at different magnitudes of DC input voltage. The controller can be configured to operate the voltage boost converter to increase the DC input voltage to different magnitudes that are specific to different thresholds or intervals representing a pre-defined low level of DC input voltage. Generally, the DC input voltage or increased DC input voltage supplied to the output port shall be on level to properly charge a given energy storage device. Based on the present disclosure, a person skilled in the art will be able to define appropriate functions and software algorithms and implement these in the controller.

In a preferred embodiment of the charging circuit of the invention, the controller is configured, when operating the voltage boost converter, to increase a DC input voltage of 400 V to 800 V and supply it to the output port.

This is a particularly beneficial configuration for many state of the art energy storage devices, for example in field of electrical vehicles.

In a preferred embodiment of the charging circuit of the invention, the neutral side of the AC electrical machine system comprises a plurality of neutral points, each arranged in a separate parallel electrical path and with an additional selective electronic gate arranged in each path, said additional gate having at least one operational state with a conducting direction towards the neutral point and a reverse direction towards a common joint of said paths being electrically connected to the switching element and the DC input voltage bypass.

If the charging circuit of the invention is operated by the controller as an electric drive system, this effectively prevents current flows between the different neutral points, for example with regard to circulating currents. However, during operation as the voltage boost converter it is required that current can flow to the different neutral points in parallel.

In a preferred embodiment of the charging circuit of the invention, that is a specific further development of the previous embodiment, the AC electrical machine system comprises a plurality of AC electrical machines, each of them providing one of said neutral points.

For example, this allows the charging system of the invention being used with a plurality of drive motors comprised by the AC electrical machine system, thereby still maintaining a low technical complexity.

In a preferred embodiment of the charging circuit of the invention, the selective electronic gate comprises a diode.

The diode is a very simple, reliable and effective solution to realize the selective electronic gate and is therefore preferred in the context of the disclosed invention.

Alternatively, a transistor could be applied. In that case, the base of the transistor can be controlled by the controller. For example, the transistor can be switched-on permanently to have the conducting direction towards the output port and the reverse direction towards the input port. The transistor can also be switched-off, for example to save energy, if the controller operates the voltage boost converter, so that the DC input voltage bypass is electrically interrupted.

In a preferred embodiment of the charging circuit of the invention, a capacitor is applied between a positive side and a negative side of the charging circuit, a second switching element is provided in series with the capacitor and these components are arranged in a way that at least one of the following configurations are achievable:
a pre-charging configuration, wherein the electrical connection between the input port and the output port via the AC electrical machine system and the AC/DC-inverter is interrupted and wherein the capacitor is chargeable by the DC input voltage supplied to the input port;
an alternative pre-charging configuration, wherein the electrical connection between the input port and the output port via the AC electrical machine system and the AC/DC-inverter is enabled and wherein the capacitor is chargeable by the drive voltage supplied to the output port;
a discharging configuration, wherein the electrical connection between the input port and the output port via the AC electrical machine system and the AC/DC-inverter is interrupted, the positive side and negative side of the charging circuit are electrically connected via the AC/DC-inverter and wherein energy stored in the capacitor dissipates while circulating in an electric loop formed by the capacitor, the switching element, the AC electrical machine system, the AC/DC-inverter and the negative side of the charging circuit.

If it is referred herein to the positive side and the negative side of the charging circuit, this applies to those components that are (relative to each other) at a high electrical potential (positive side) or a low electrical potential (negative side). In simple words it refers to the “+” or “−” sides of the charging circuit. It is self-evident to a person skilled in the art, that having a polarity implies either a DC input voltage being supplied to the input port or a drive voltage being supplied to the output port.

By pre-charging the capacitor, the electrical potential of the charging circuit can be adapted to the DC input voltage or drive voltage applied, in order to avoid a sudden increase of the electrical potential at the moment the DC input voltage or drive voltage is applied to the charging circuit. This enhances the technical security and durability of the charging circuit.

If the external charging device is not capable of providing an adapted pre-charging DC input voltage, for example a slowly increasing DC input voltage, an electrical resistance or functionally similar component can be combined with the capacitor to avoid damage to the capacitor.

Beneficially, if pre-charging is done via the AC electrical machine system, no additional electrical resistance or the like is required, as the pre-charging current flows through the inductors of the AC electrical machine system.

By discharging the capacitor, it is avoided that the input port remains at an electrical potential according to the DC input voltage/the drive voltage, after the charging process of the energy storage device has been finished and the external charging device has been removed. This further enhances the technical security of the charging circuit. A person skilled in the art, in view of the present disclosure, will understand that the pre-charging state or discharging state of the capacitor should be controlled by appropriate measures and preferably by involvement of the controller of the charging circuit of the invention for this purpose.

In a preferred embodiment of the charging circuit of the invention, the controller is configured to run at least one of the following modes:
a pre-charging mode, wherein the pre-charging configuration is created by interrupting the electrical connection between the input port and the output port via the AC electrical machine system and the AC/DC-inverter, opening the switching element and closing the second switching element;
an alternative pre-charging mode, wherein the alternative pre-charging configuration is created by opening the second switching element, closing the switching element and enabling the electrical connection between the input port and the output port via the AC electrical machine system and the AC/DC-inverter 22;
a discharging mode, wherein the discharging configuration is created by opening the second switching element, closing the switching element and interrupting the electrical connection between the input port and the output port via the AC electrical machine system and the AC/DC-inverter, while connecting the positive side and the negative side of the charging circuit via the AC/DC-inverter.

Another aspect of the invention refers to a charging system, comprising:
a charging circuit according to the previous description; and
an energy storage device electrically connected to an output port of the charging circuit.

Preferably, the energy storage device comprises a chargeable battery. Further preferred, the energy storage device comprises a chargeable battery for a vehicle.

In a preferred embodiment of the charging system of the invention, a controller is configured to operate the voltage boost converter to increase the DC input voltage to a level required to charge the energy storage device, if the DC input voltage is lower and to interrupt the electrical connection between the input port and output port via the AC electrical machine system and AC/DC-inverter, if the DC input voltage at least at the level required to charge the energy storage device.

This way, the energy storage device is always charged efficiently and safely at low technical effort.

In a preferred embodiment of the charging system of the invention, it further comprises an external charging device compatible with an input port of the charging circuit and configured of delivering at least one DC input voltage.

Preferably, the external charging device is also adapted to provide a signal representing the applied DC input voltage, for example to the controller of the charging circuit. Further preferred, the external charging device is also adapted to receive signals, for example from the charging circuit. Such signals can be used to provide information on the charging state of the energy storage device, for example.

Another aspect of the invention refers to a vehicle, comprising at least one of the following:
a charging circuit according to the previous description;
a charging system according to the previous description.
   The energy storage device of the vehicle of the invention can be charged efficiently, flexible, safely and at low technical effort. In particular, it does not depend on any external charging device that is specifically designed for the charge voltage specification of the energy storage device. That is why the vehicle of the invention is particularly flexible.

Another aspect of the invention refers to a method of operating a charging system according to the previous description, comprising the following steps:
I) Connection of an external charging device to an input port;
II) Delivery of a DC input voltage to the input port;
III) Detection of a voltage level of the DC input voltage by a controller; and
A) Performing the following actions, if the DC input voltage is at a pre-defined high level:
IV-A) Interruption of an electrical connection between the input port and an output port via an AC electrical machine system and a AC/DC-inverter by the controller;
V-A) Delivery of the DC input voltage to the output port via a DC input voltage bypass in a conducting direction of a selective electronic gate;
VI-A) Charging an energy storage device electrically connected to an output port; or
B) Performing the following actions, if the DC input voltage is at a pre-defined low level:
IV-B) Operation of the AC/DC-inverter and the AC electrical machine system as a voltage boost converter by the controller to increase the DC input voltage;
V-B) Delivery of the increased DC input voltage to the output port via the AC/DC-inverter;
VI-B) Charging the energy storage device electrically connected to the output port.

In a preferred embodiment of the method of the invention, at least one of the following steps is performed:
I-a) implemented in step I, wherein the controller is running a pre-charging mode by interrupting the electrical connection between the input port and the output port via the AC electrical machine system and the AC/DC-inverter, opening a switching element and closing a second switching element and then the DC input voltage is delivered from the plugged-in external charging device to the capacitor;
I-b) implemented in step I or performed prior to step I, wherein the controller is running an alternative pre-charging mode by opening the second switching element, closing the switching element and enabling the electrical connection between the input port and the output port via the AC electrical machine system and the AC/DC-inverter and then a drive voltage is delivered from the energy storage device to the capacitor;
VII) performed after step VI-A or VI-B, wherein the controller is running a discharging mode, by opening the second switching element, closing the switching element and interrupting the electrical connection between the input port and the output port via the AC electrical machine system and the AC/DC-inverter, while connecting a positive side and a negative side of the charging circuit via the AC/DC-inverter and then energy stored in the capacitor dissipates while circulating in an electric loop formed by the capacitor, the switching element, the AC electrical machine system, the AC/DC-inverter and the negative side of the charging circuit.

In a preferred embodiment of the method of the invention, a diode is used in step V-A) to deliver the DC input voltage in the conducting direction to the output port and to prevent backflow of current in the reverse direction to the input port.

In a preferred embodiment of the method of the invention, the charging system belongs to a vehicle and the energy storage device of the vehicle is charged.

To be summarized in other words, the disclosed invention refers to a charging circuit and a charging system to charge a battery of an electric vehicle. The charging circuit comprises an AC/DC-inverter and an AC electrical machine system, that can selectively be run as a voltage boost converter or an electric drive system. In the charging circuit, a DC input voltage can, after passing a switching element but before entering the AC electrical machine system, be grabbed of and led via a selective electronic gate to reach an output port of the charging circuit in a conducting direction of the gate. At the same time, any backflow of current to an input port of the charging circuit is prevented in a reverse direction of the gate.

Unless indicated otherwise, all embodiments described herein are compatible with each other and the beneficial technical effects apply respectively.

### BRIEF DESCRIPTION OF THE DRAWINGS

The invention will be described in further detail below with reference to the accompanying drawings, in which

FIG. 1 is a schematic view of an embodiment of a charging circuit;

FIG. 2 is a schematic view of an alternative embodiment of a charging circuit;

FIG. 3 is a schematic view of a further embodiment of a charging circuit compatible with those of FIGS. 1 and 2;

FIG. 4 is a block diagram of an embodiment of a method of operating a charging system;

FIG. 5 is a schematic view of an embodiment of a charging system comprising the charging circuit of FIG. 1 or 2 operated in the method of FIG. 4;

FIG. 6 is another schematic view of the embodiment of the charging system of FIG. 5;

FIG. 7 is a schematic view of an embodiment of a charging system comprising a charging circuit of FIG. 3 operated in the method of FIG. 4;

FIG. 8 is another schematic view of the embodiment of the charging system of FIG. 7; and

FIG. 9 is a schematic view of any of the disclosed charging systems operated in an embodiment of the method of FIG. 4, illustrating pre-charging and discharging currents.

Further, FIG. 10 illustrates another technical solution that is not part of the invention.

### DETAILED DESCRIPTION

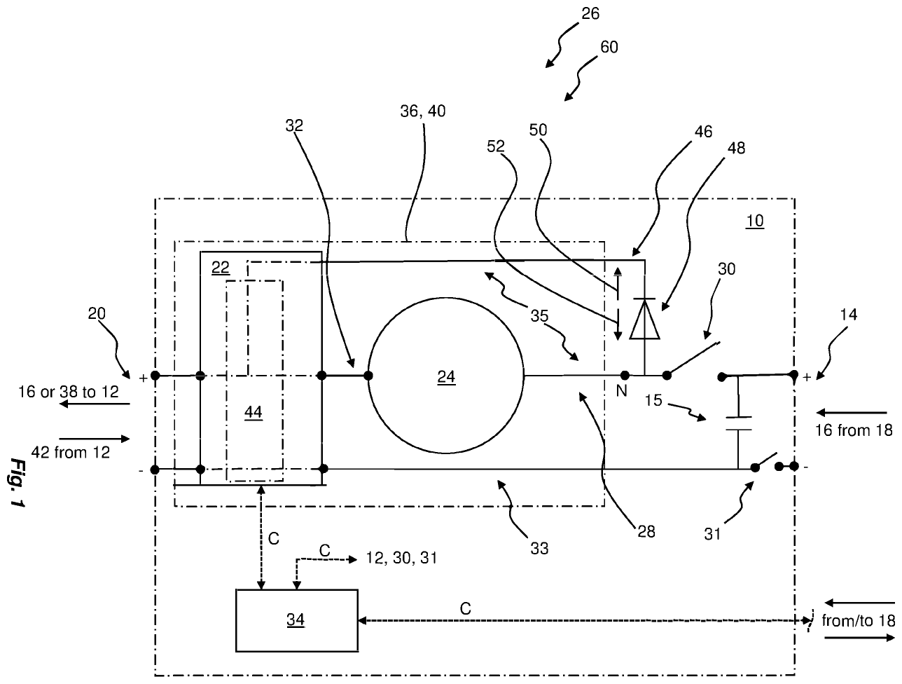

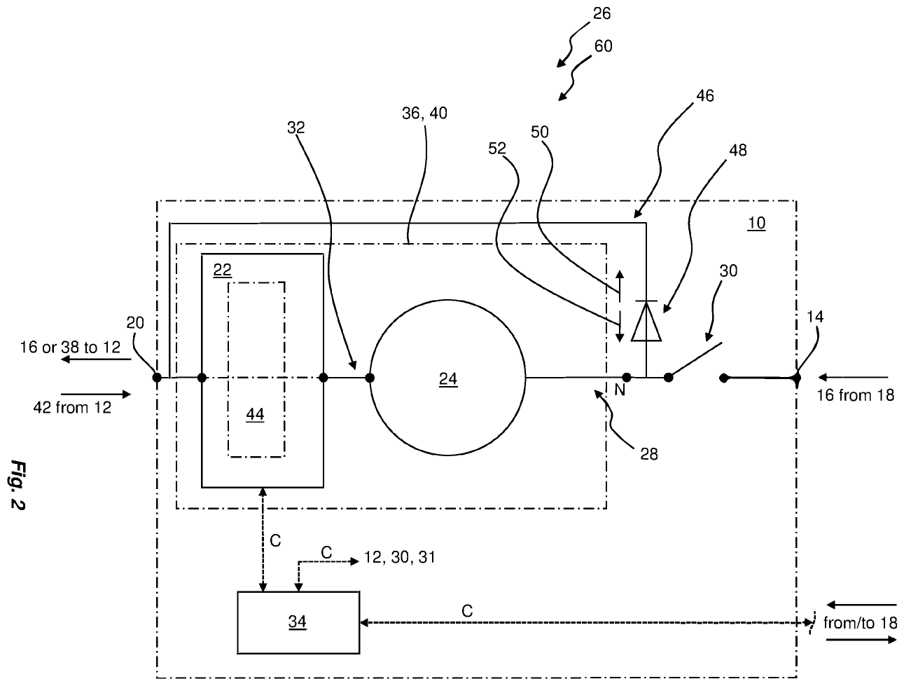

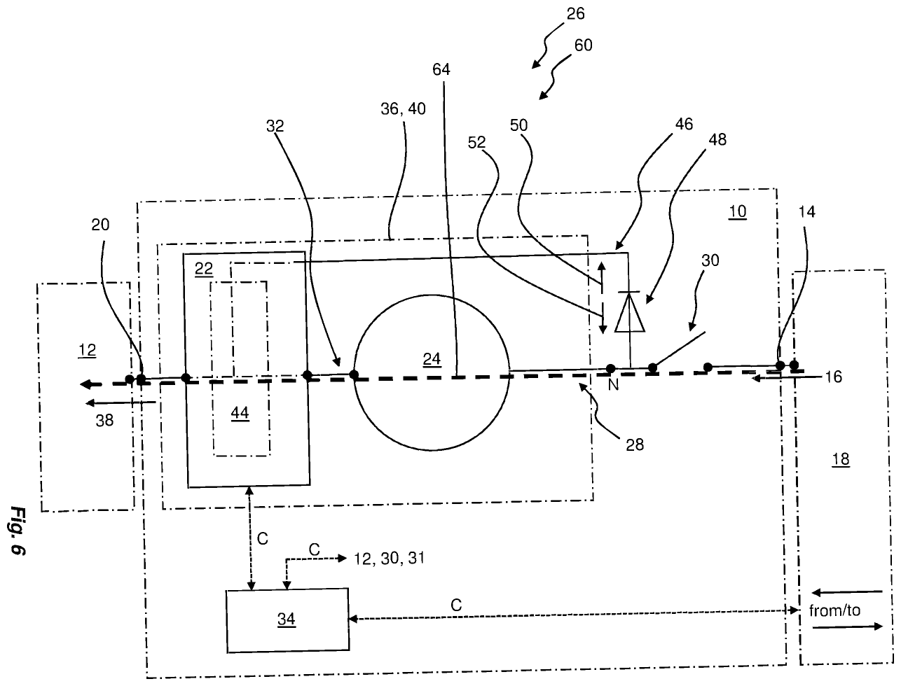

Starting with FIG. 1, a charging circuit 10 is schematically shown. The charging circuit 10 is designed to charge an energy storage device 12 (see FIGS. 5 to 8). The charging circuit 10 comprises an input port 14, designed to receive a DC input voltage 16 from an external charging device 18 (see FIGS. 5 to 8). At the input port 14, the electrical polarity is schematically indicated by “+” and “−”.

The charging circuit 10 further comprises an output port 20, electrically connectable to the energy storage device 12. At the output port 20, again the electrical polarity is schematically indicated by “+” and “−”. With respect to the polarity, it is also referred to a positive side 35 and a negative side 33 of the charging circuit 10 herein. The polarities are a result of the external charging device 18 being applied to the input port 14, accordingly and/or of the energy storage device 12 being applied to the output port 20, respectively.

Optionally but preferably, a capacitor 15 is applied between the positive side 35 and negative side 33, right at the input port 14. It is also optional but preferred to apply a second switching element 31 at the negative side 33, that is in series with the capacitor 15.

Further, an AC/DC-inverter 22 is provided, being electrically connected to the output port 20. The AC/DC-inverter 22 is electrically connected to an AC electrical machine system 24, for example an electric drive motor for a vehicle 26. In this example, the charging circuit 10 forms part of a charging system 60 (see FIGS. 5 to 8) of a vehicle 26 (not shown in more detail), but in principle could also belong to any other technical system with an electric drive and an energy storage device 12.

The AC electrical machine system 24 comprises a neutral side 28 with a neutral point N being electrically connected to the input port 14 via a switching element 30.

Via the switching element 30 the DC input voltage 16 can be selectively supplied to the neutral side 28.

The AC electrical machine system 24 also comprises a phase side 32 being electrically connected to the AC/DC-inverter 22.

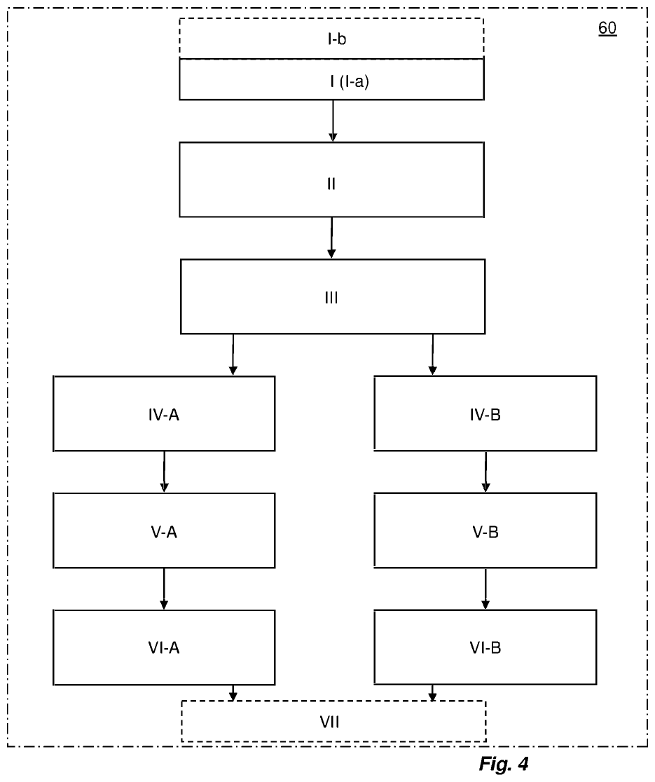

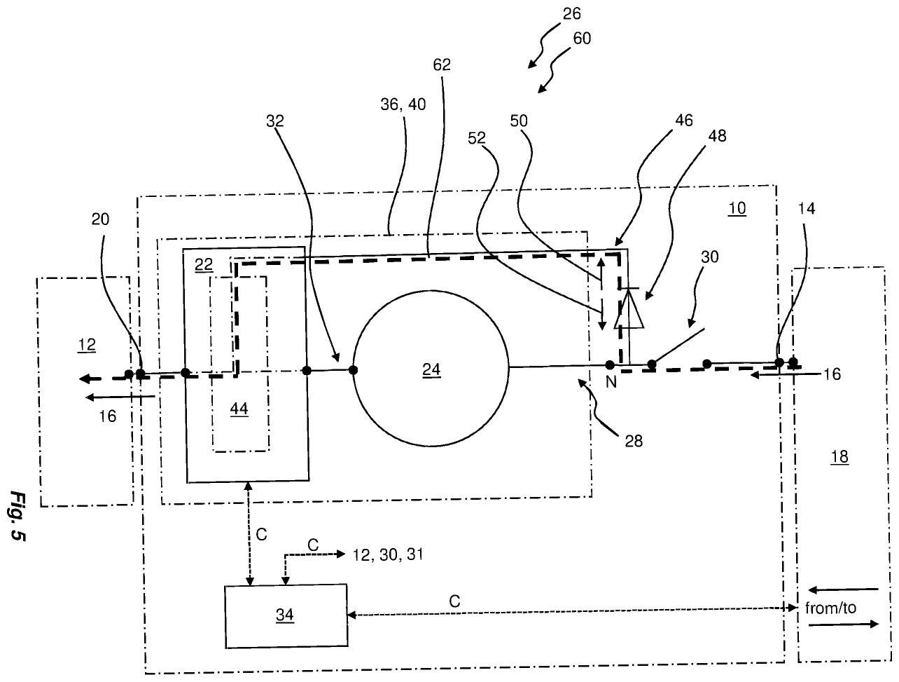

Further, the charging circuit 10 comprises a controller 34. The controller 34 has a configuration that allows it to selectively operate in different modes. These modes are briefly described in the following and will be further described with reference to FIG. 4-8.

One of these modes is to operate the AC/DC-inverter 22 and the AC electrical machine system 24 as a voltage boost converter 36. In this mode, the DC input voltage 16 is increased and supplied to the output port 20 via the AC/DC-inverter 22 as an increased DC input voltage 38.

Another mode is to operate the AC/DC-inverter 22 and the AC electrical machine system 24 as an electric drive system 40 to convert and supply a drive voltage 42 of the energy storage device 12 from the output port 20 to the AC electrical machine system 24.

Another mode is to interrupt the electrical connection between the input port 14 and output port 20 via the AC electrical machine system 24 and AC/DC-inverter 22, for example by appropriate control of internal electric or electronic components 44 of the AC/DC-inverter 22.

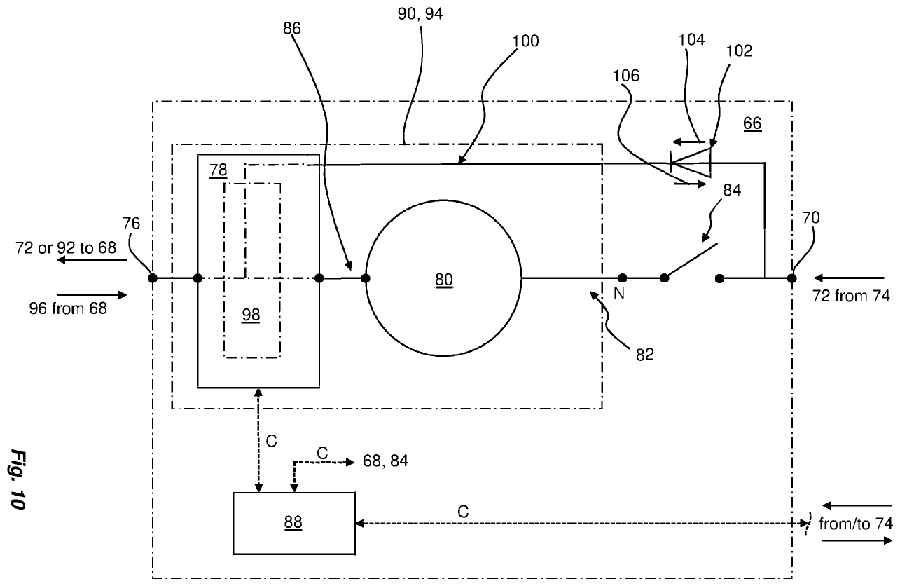

Yet another optional but preferred mode is to pre-charge or discharge the capacitor 15, for example by appropriate control of the switching element 30, the second switching element 31 and the internal electric or electronic components 44. Further explanation will be given with additional reference to FIGS. 4 and 9. It shall be noticed, that all the teachings provided herein about or related to the positive and negative sides 33, 35 or polarities, the capacitor 15, the second switching element 31 and the pre-charging and discharging modes of the controller 34 do optionally but preferably also apply to all other technical solutions illustrated in the other figures. Merely for simpler illustration, these elements are only shown in FIGS. 1 and 9.

To execute the modes stated above, the controller 34 is configured and adapted to send and/or receive various control signals C. The control signals C can for example be sent to or received from the AC/DC-inverter 22 in order to control said internal electric or electronic components 44, such as switches, relays or diodes (these are well known in the art and therefore not shown here). Further, the control signals C can for example be sent to or received from the external charging device 18. For example, the controller 34 can receive information on the DC input voltage 16 or send information about a charging state of the energy storage device 12. Further, the control signals C can for example be sent to or received from the switching element 30 or other components typically comprised by a charging circuit 10 of the present type that are not further illustrated. Those well-known other components can exemplarily be seen in the cited prior art.

Between the neutral side 28 and the switching element 30, a DC input voltage bypass 46 is provided. It is running from between the neutral side 28 and the switching element 30 to the output port 20 via a selective electronic gate 48.

The selective electronic gate 48 preferably comprises a diode. Even though the selective electronic gate 48 in the present disclosure is throughout illustrated by the symbol of a diode, it is not limited thereto. For example, the selective electronic gate 48 can also comprise a transistor or another electronic device that fulfils the requirements describe in the following.

Firstly, the selective electronic gate 48 has a least one operational state with a conducting direction 50 towards the output port 20. Secondly, the selective electronic gate 48 has a reverse direction 52 towards the input port 14 in that operational state.

In the embodiment described with regard to FIG. 1, the DC input voltage bypass 46 is running to the output port 20 via the AC/DC-inverter 22. If the controller 34 interrupts the electrical connection between the input port 14 and output port 20 via the AC electrical machine system 24 and AC/DC-inverter 22, the electrical connection of the DC input voltage bypass 46 to the output port 20 via the AC/DC-inverter 22 is still available. The interruption can therefore, as an example, be realized by electrically disconnecting the AC electrical machine system 24 and AC/DC-inverter 22, for example by appropriate control of internal switches of the AC/DC-inverter 22.

The AC/DC-inverter 22 is located electrically downstream the selective electronic gate 48 in the conducting direction 50.

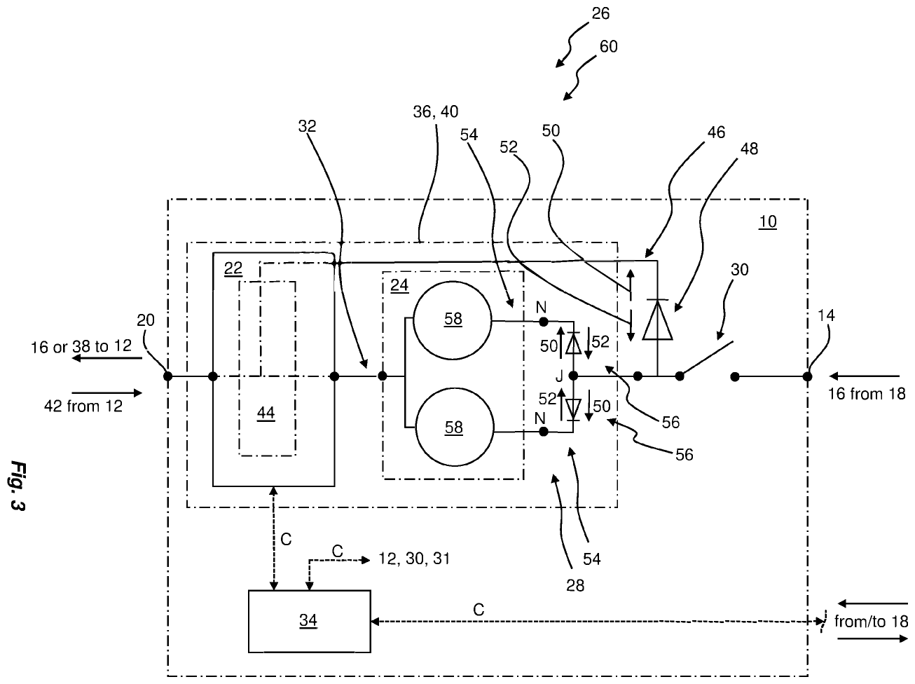

Now turning to FIG. 2 it shall first be underlined that the embodiment presented therein and that of FIG. 1 are to a large extent identical. Therefore, only the difference will be explained. Apart from that, the description of FIG. 1 applies to FIG. 2, as well.

As can be seen in FIG. 2, the DC input voltage bypass 46 is bypassing the AC/DC-inverter 22. It is preferably running directly to the output port 20, which is however not mandatory.

Now turning to FIG. 3, another embodiment is described. It is compatible with both embodiments described with regard to FIGS. 1 and 2. Therefore, the description of FIGS. 1 and 2 applies to FIG. 3, as well.

Merely for exemplarily illustration, the DC input voltage bypass 46 shown in FIG. 3 is illustrated as in FIG. 1. However, it can also be designed as shown in FIG. 2, alternatively.

FIG. 3 shows an embodiment, wherein the neutral side 28 of the AC electrical machine system 24 comprises a plurality of neutral points N. Each of said neutral points N are arranged in a separate parallel electrical path 54. Each of said parallel electrical paths 54 comprises an additional selective electronic gate 56.

Each of said additional selective electronic gates 56 comprise at least one operational state with a conducting direction 50 towards the neutral point N of the dedicated electrical path 54. Further, each of said additional selective electronic gates 56 comprises a reverse direction 52 towards a common joint J of said paths 54 being electrically connected to the switching element 30 and the DC input voltage bypass 46.

In the described example, the AC electrical machine system 24 comprises a plurality of AC electrical machines 58, each of them providing one of said neutral points N. However, it could also be an AC electrical machine system 24 with a single AC electrical machine 58 that has a plurality of parallel electrical paths with each of these paths connected to an individual neutral point N. It could also be any other single electrical machine 58 that has a plurality of neutral points N.

Reference is now made to FIG. 4. Therein, a block diagram is shown describing a method of operating a charging system 60, further described in FIGS. 5 to 8. The charging system 60 is based on a charging circuit 10 as previously described in FIGS. 1 to 3 and with the energy storage device 12 electrically connected to the output port 20 of the charging circuit 10 of the charging system 60. Therefore, it is referred to the description of FIGS. 1 to 3, when the components illustrated therein are addressed with regard to FIG. 4.

In a first step I of the method illustrated in FIG. 4, a connection is made between the external charging device 18 and the input port 14. For example, the external charging device 18 is plugged-in to the input port 14.

In an optional but preferred step I-a, that is implemented in step I, the controller 34 is running a pre-charging mode. Therein, the electrical connection between the input port 14 and the output port 20 via the AC electrical machine system 24 and the AC/DC-inverter 22 is interrupted. For example, the controller 34 can control the internal electric or electronic components 44 accordingly. The switching element 30 remains open and the second switching element 31 is closed. Thus, a pre-charging current 65 (see FIG. 9) delivered from the plugged-in external charging device 18 can charge the capacitor 15. For electrical security, an electrical resistance (not shown) is preferably connected in series with the capacitor 15 and the input port 14 on the negative side 33.

Alternatively, in an optional but preferred step I-b, that is implemented in step I or accomplished prior to step I, the controller 34 is running an alternative pre-charging mode. Therein, the capacitor 15 can be pre-charged even without the external charging device 18 being connected to the input port 14. In this case, the pre-charging is done by the energy storage device 12. For that purpose, the controller 34 can open the second switching element 31, close switching element 30 and allow the electrical connection between the input port 14 and the output port 20 via the AC electrical machine system 24 and the AC/DC-inverter 22. Thus, the pre-charging current 67 (see FIG. 9) delivered from the energy storage device 12 can charge the capacitor 15. No additional electrical resistance is required, as the pre-charging current 67 flows through the AC electrical machine system 24.

In a second step II, the external charging device 18 delivers the DC input voltage 16 to the input port 14.

In a third step III, a voltage level of the DC input voltage 16 is detected by the controller 34. For example, this can be done by the controller 34 being configured to measure the DC input voltage 16 or by a control signal C being sent by the external charging device 18 to the controller 34, corresponding to the DC input voltage 16. The controller 34 determines, whether the DC input voltage 16 is at a pre-defined high level or at a pre-defined low level. For example, the pre-defined high level can be set at 800 V and the pre-defined low level can be set at 400 V. In this example, the energy storage device 12 electrically connected to the output port 20 has a required charging voltage of 800 V and the external charging device 18 is capable of delivering 400 V or 800 V as the DC input voltage 16.

If the DC input voltage 16 is delivered at the pre-defined high level, step IV-A follows. Therein, an electrical connection between the input port 14 and the output port 20 is interrupted via the AC electrical machine system 24 and a AC/DC-inverter 22 by the controller 34.

Then in step V-A the DC input voltage 16 at the pre-defined high level is delivered to the output port 20 via the DC input voltage bypass 46 in the conducting direction 50 of the selective electronic gate 48.

As a result, the energy storage device 12 is charged by the DC input voltage 16 via the output port 20 in step VI-A.

Alternatively, if the DC input voltage 16 detected by the controller 34 is at the pre-defined low level, step IV-B follows step III.

Therein, the AC/DC-inverter 22 and the AC electrical machine system 24 are operated as the voltage boost converter 36 by the controller 34 to increase the DC input voltage 16 to the increased DC input voltage 38 to the pre-defined high level of 800 V.

In a step V-B, this increased DC input voltage 38 is delivered to the output port 20 via the AC/DC-inverter 22.

Accordingly, the energy storage device 12 is charged by the increased DC input voltage 38 via the output port 20 in step VI-B.

Once step VI-A or VI-B, which means charging the energy storage device 12, is accomplished, an optional but preferred step VII follows. Therein, the controller 34 is running a discharging mode in order to discharge the capacitor 15. For that purpose, the second switching element 31 is opened, the switching element 30 is closed and the electrical connection between the input port 14 and the output port 20 via the AC electrical machine system 24 and the AC/DC-inverter 22 is interrupted. At the same time, the positive side 35 and the negative side 33 of the charging circuit 10 are connected via the AC/DC-inverter 22, preferably by appropriate control of the internal electric or electronic components 44. Thus, the capacitor 15 can be discharged as the stored energy dissipates while circulating as a discharging current 69 (see FIG. 9) in an electric loop formed by the capacitor 15, the switching element 30, the AC electrical machine system 24, the AC/DC-inverter 22 and the negative side 33.

Preferably, a diode is used in step IV-A to deliver the DC input voltage 16 in the conducting direction 50 to the output port 20 and to prevent backflow of current in the reverse direction 52 to the input port 14.

Preferably, the charging system 60 used in the method forms part of the vehicle 26 and the energy storage device 12 of the vehicle 26 is charged.

Turning now to FIG. 5 and with regard to FIGS. 1, 2 and 4, the charging system 60 operated in the method is illustrated. Accordingly, the description of the respective Figures applies.

In case of step IV-A of the method, the DC input voltage 16 is at the pre-defined high level, for example 800 V and is delivered to the output port 20 via the DC input voltage bypass 46 in the conducting direction 50 of the selective electronic gate 48 to charge the energy storage device 12. This is indicated by thick current flow line 62. It is self-evident to a skilled person, that switching element 30 is in a closed state at that time.

No current flows from the input port 14 to the output port 20 via the AC electrical machine system 24 and an AC/DC-inverter 22 at that time.

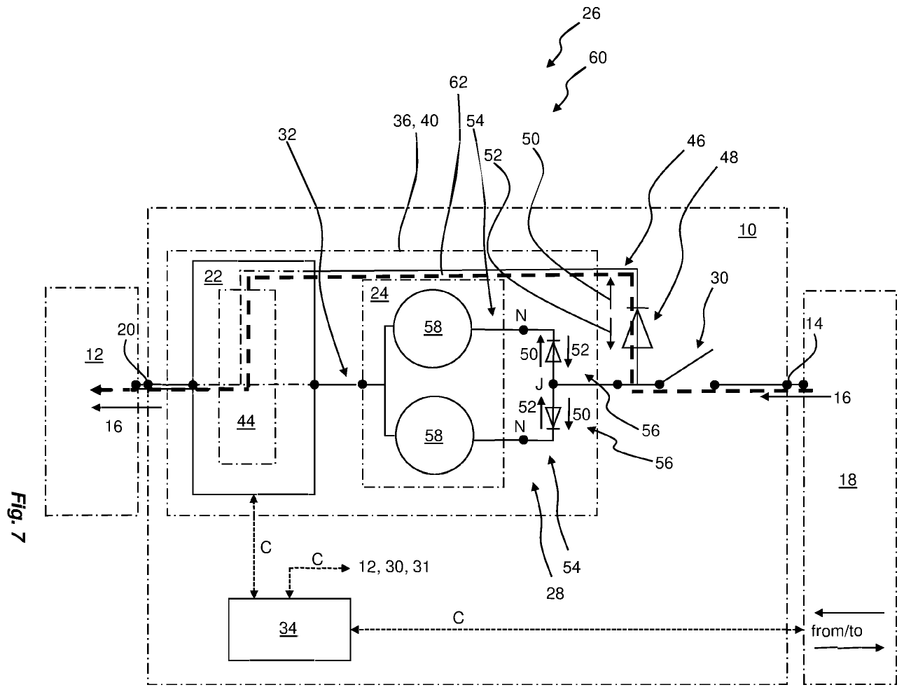

Turning now to FIG. 6, the charging system 60 from FIG. 5 is shown, operated in step IV-B of the method. Therein, the DC input voltage 16 is at the pre-defined low level, for example 400 V and the AC/DC-inverter 22 and the AC electrical machine system 24 are operated as the voltage boost converter 36 by the controller 34 to increase the DC input voltage 16 to the increased DC input voltage 38 to charge the energy storage device 12. This is indicated by thick current flow line 64. No current flows from the input port 14 to the output port 20 via the DC input voltage bypass 46 at that time.

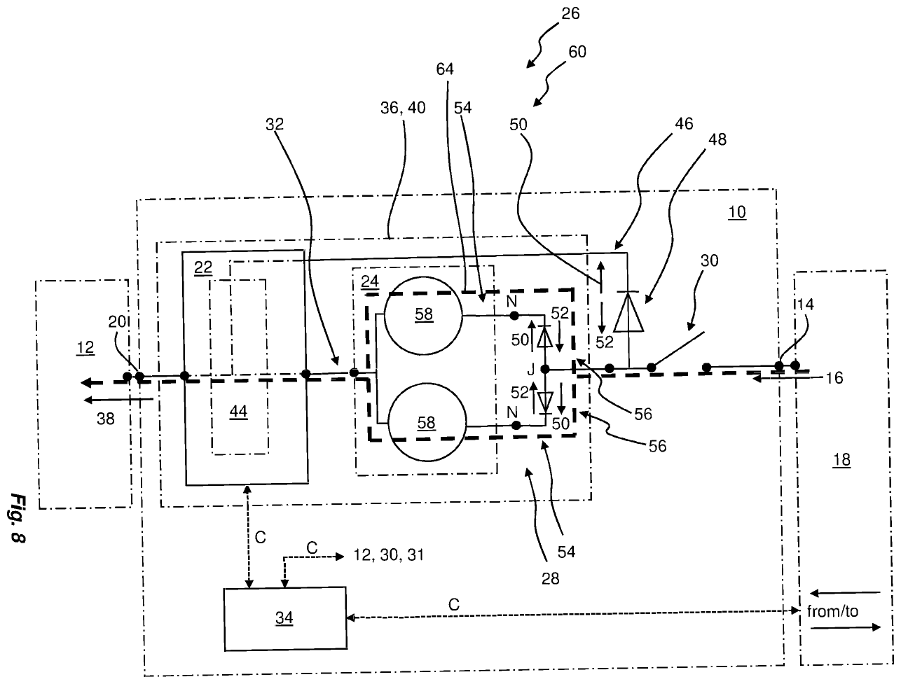

Turning now to FIG. 7 and with regard to FIGS. 3 and 4, the charging system 60 operated in the method is illustrated. Accordingly, the description of the respective Figures applies.

In case of step IV-A of the method, the DC input voltage 16 is at the pre-defined high level, for example 800 V and is delivered to the output port 20 via the DC input voltage bypass 46 in the conducting direction 50 of the selective electronic gate 48 to charge the energy storage device 12. This is indicated by thick current flow line 62. It is self-evident to a skilled person, that switching element 30 is in a closed state at that time.

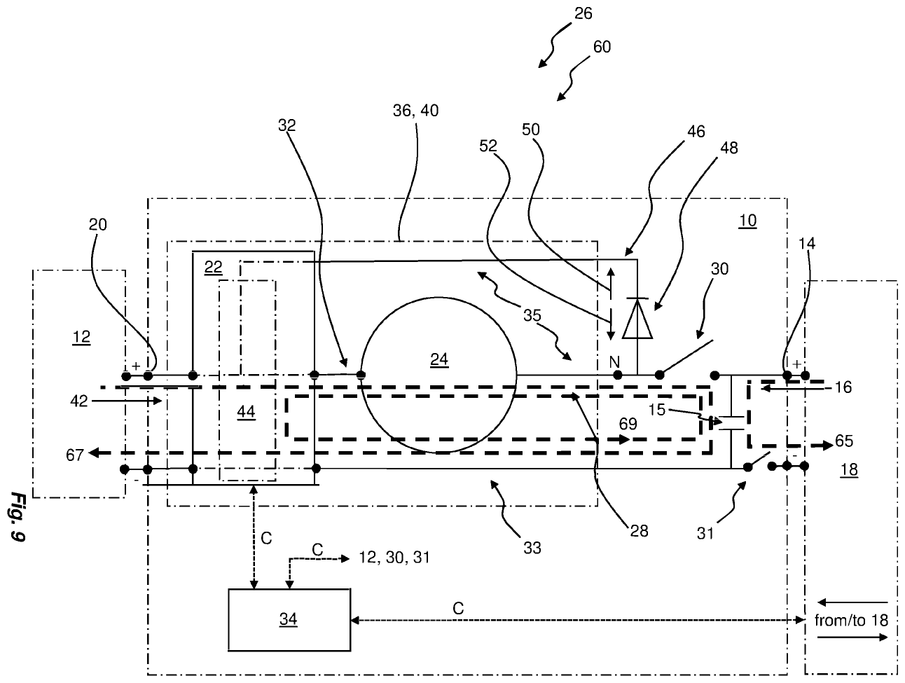

Turning now to FIG. 8, the charging system 60 from FIG. 7 is shown, operated in step IV-B of the method. Therein, the DC input voltage 16 is at the pre-defined low level, for example 400 V and the AC/DC-inverter 22 and the AC electrical machine system 24 are operated as the voltage boost converter 36 by the controller 34 to increase the DC input voltage 16 to the increased DC input voltage 38 to charge the energy storage device 12. For example, the increased DC input voltage 38 is 800 V. This is indicated by thick current flow line 64. No current flows from the input port 14 to the output port 20 via the DC input voltage bypass 46 at that time. In this example it is illustrated, how the current flows into the electrical machine system 24 via the different parallel electrical paths 54 in the conducting directions 50 of the dedicated additional selective electronic gates 56.

Now briefly turning to FIG. 9, a schematic view of the charging system 60 operated in an embodiment of the method shown in FIG. 4 is illustrated. The main intention of FIG. 9 is to illustrate the pre-charging currents 65, 67 and the discharging current 69 in steps I-a, I-b and VII.

Finally turning to FIG. 10, another technical solution that is not part of the invention is illustrated.

Another charging circuit 66 is schematically shown. The charging circuit 66 is designed to charge an energy storage device 68. The charging circuit 66 comprises an input port 70, designed to receive a DC input voltage 72 from an external charging device 74.

The charging circuit 66 further comprises an output port 76, electrically connectable to the energy storage device 68. Further, an AC/DC-inverter 78 is provided, being electrically connected to the output port 76. The AC/DC-inverter 78 is electrically connected to an AC electrical machine system 80, for example an electric drive for a vehicle. The charging circuit 66 belongs to a charging system, comprising the energy storage device 68 electrically connected to an output port 76 of the charging system and further the external charging device 74 compatible with the input port 70 of the charging circuit 66 and configured of delivering at least one DC input voltage 72. For example, the charging circuit 66 could belong to a charging system of the vehicle, but could also belong to any other technical system with an electric drive and an energy storage device 68.

The AC electrical machine system 80 comprises a neutral side 82 with a neutral point N being electrically connected to the input port 70 via a switching element 84.

Via the switching element 84 the DC input voltage 72 can be selectively supplied to the neutral side 82.

The AC electrical machine system 80 also comprises a phase side 86 being electrically connected to the AC/DC-inverter 78.

Further, the charging circuit 66 comprises a controller 88. The controller 88 has a configuration that allows it to selectively operate in different modes. These modes are briefly described in the following.

One of these modes is to operate the AC/DC-inverter 78 and the AC electrical machine system 80 as a voltage boost converter 90. In this mode, the DC input voltage 72 is increased and supplied to the output port 76 via the AC/DC-inverter 78 as an increased DC input voltage 92.

Another mode is to operate the AC/DC-inverter 78 and the AC electrical machine system 80 as an electric drive system 94 to convert and supply a drive voltage 96 of the energy storage device 68 from the output port 76 to the AC electrical machine system 80.

Another mode is to interrupt the electrical connection between the input port 70 and output port 76 via the AC electrical machine system 80 and AC/DC-inverter 78, for example by appropriate control of internal electric or electronic components 98 of the AC/DC-inverter 78.

To execute these modes, the controller 88 is configured and adapted to send and/or receive various control signals C. The control signals C can for example be sent to or received from the AC/DC-inverter 78 in order to control said internal electric or electronic components 98, such as switches, relays or diodes. Further, the control signals C can for example be sent to or received from the external charging device 74. For example, the controller 88 can receive information on the DC input voltage 72 or send information about a charging state of the energy storage device 68. Further, the control signals C can for example be sent to or received from the switching element 84 or other components typically comprised by a charging circuit 66 of the present type that are not further illustrated. Those well-known other components can exemplarily be seen in the cited prior art.

Between the switching element 84 and the input port 70, a DC input voltage bypass 100 is provided. It is running from between the input port 70 and the switching element 84 to the output port 76 via a selective electronic gate 102.

The selective electronic gate 102 may comprise a diode, a transistor or another electronic device that fulfils the requirements describe in the following.

Firstly, the selective electronic gate 102 has a least one operational state with a conducting direction 104 towards the output port 76. Secondly, the selective electronic gate 102 has a reverse direction 106 towards the input port 70 in that operational state.

In the technical solution described in FIG. 1, the DC input voltage bypass 100 is running to the output port 76 via the AC/DC-inverter 78 but could also bypass the AC/DC-inverter 78 in other solutions.

If the controller 88 interrupts the electrical connection between the input port 70 and output port 76 via the AC electrical machine system 80 and AC/DC-inverter 78, the electrical connection of the DC input voltage bypass 100 to the output port 76 via the AC/DC-inverter 78 is, however, still available. The interruption can therefore, as an example, be realized by electrically disconnecting the AC electrical machine system 80 and AC/DC-inverter 78, for example by appropriate control of internal switches of the AC/DC-inverter 78.

The AC/DC-inverter 78 is located electrically downstream the selective electronic gate 102 in the conducting direction 104.

This technical solution however lacks electrical security, as there is no mechanical separation between the input port 70 and the output port 76. This could be overcome by adding such a separation, for example a mechanical switch such as a relay between the input port 70 and the selective electronic gate 102. However, in that case there would be no benefit with regard to the prior art.

1. A charging circuit for an energy storage device, comprising:
an input port, designed to receive a DC input voltage from an external charging device;
an output port, electrically connectable to an energy storage device;
an AC/DC-inverter, electrically connected to the output port;
an AC electrical machine system, comprising a neutral side being electrically connected to the input port via a switching element, so that the DC input voltage can be selectively supplied to the neutral side, further comprising a phase side being electrically connected to the AC/DC-inverter;
a controller, at least configured to selectively operate the AC/DC-inverter and the AC electrical machine system as a voltage boost converter to increase the DC input voltage and supply it to the output port, or as an electric drive system to convert and supply a drive voltage of the energy storage device from the output port to the AC electrical machine system, or to interrupt the electrical connection between the input port and output port via the AC electrical machine system and AC/DC-inverter,
characterized in that a DC input voltage bypass is provided, running from between the neutral side and the switching element via a selective electronic gate to the output port, said gate having a least one operational state with a conducting direction towards the output port and a reverse direction towards the input port.

2. The charging circuit according to claim 1, wherein the DC input voltage bypass is bypassing the AC/DC-inverter.

3. The charging circuit according to claim 1, wherein the DC input voltage bypass is running to the output port via the AC/DC-inverter, that is located electrically downstream the selective electronic gate in the conducting direction.

4. The charging circuit according to claim 1, wherein the controller is configured to measure the DC input voltage or to receive a signal from the external charging device corresponding to the DC input voltage and, if the DC input voltage is at a pre-defined low level operate the voltage boost converter and if the DC input voltage is at a pre-defined high level interrupt the electrical connection between the input port and output port via the AC electrical machine system and AC/DC-inverter.

5. The charging circuit according to claim 1, wherein the controller is configured, when operating the voltage boost converter, to increase a DC input voltage of 400 V to 800 V and supply it to the output port.

6. The charging circuit according to claim 1, wherein the neutral side of the AC electrical machine system comprises a plurality of neutral points, each arranged in a separate parallel electrical path and with an additional selective electronic gate arranged in each path, said additional gate having at least one operational state with a conducting direction towards the neutral point and a reverse direction towards a common joint of said paths being electrically connected to the switching element and the DC input voltage bypass.

7. The charging circuit according to claim 6, wherein the AC electrical machine system comprises a plurality of AC electrical machines, each of them providing one of said neutral points.

8. The charging circuit according to claim 1, wherein the selective electronic gate comprises a diode.

9. The charging circuit according to claim 1, wherein a capacitor is applied between a positive side and a negative side of the charging circuit, a second switching element is provided in series with the capacitor and these components are arranged in a way that at least one of the following configurations are achievable:
a pre-charging configuration, wherein the electrical connection between the input port and the output port via the AC electrical machine system and the AC/DC-inverter is interrupted and wherein the capacitor is chargeable by the DC input voltage supplied to the input port;
an alternative pre-charging configuration, wherein the electrical connection between the input port and the output port via the AC electrical machine system and the AC/DC-inverter is enabled and wherein the capacitor is chargeable by the drive voltage supplied to the output port;
a discharging configuration, wherein the electrical connection between the input port and the output port via the AC electrical machine system and the AC/DC-inverter is interrupted, the positive side and negative side of the charging circuit are electrically connected via the AC/DC-inverter and wherein energy stored in the capacitor dissipates while circulating in an electric loop formed by the capacitor, the switching element, the AC electrical machine system, the AC/DC-inverter and the negative side of the charging circuit.

10. The charging circuit according to claim 9, wherein the controller is configured to run at least one of the following modes:
a pre-charging mode, wherein the pre-charging configuration is created by interrupting the electrical connection between the input port and the output port via the AC electrical machine system and the AC/DC-inverter, opening the switching element and closing the second switching element;
an alternative pre-charging mode, wherein the alternative pre-charging configuration is created by opening the second switching element, closing the switching element and enabling the electrical connection between the input port and the output port via the AC electrical machine system and the AC/DC-inverter;
a discharging mode, wherein the discharging configuration is created by opening the second switching element, closing the switching element and interrupting the electrical connection between the input port and the output port via the AC electrical machine system and the AC/DC-inverter, while connecting the positive side and the negative side of the charging circuit via the AC/DC-inverter.

11. A charging system, comprising:
the charging circuit according to claim 1; and
an energy storage device electrically connected to an output port of the charging circuit.

12. The charging system according to claim 11, wherein a controller is configured to operate the voltage boost converter to increase the DC input voltage to a level required to charge the energy storage device, if the DC input voltage is lower, and to interrupt the electrical connection between the input port and output port via the AC electrical machine system and AC/DC-inverter, if the DC input voltage is at least at the level required to charge the energy storage device.

13. The charging system according to claim 11, further comprising an external charging device compatible with an input port of the charging circuit and configured of delivering at least one DC input voltage.

14. A vehicle, comprising at least one of the following:
a charging circuit for an energy storage device, comprising: an input port, designed to receive a DC input voltage from an external charging device; an output port, electrically connectable to an energy storage device; an AC/DC-inverter, electrically connected to the output port; an AC electrical machine system, comprising a neutral side being electrically connected to the input port via a switching element, so that the DC input voltage can be selectively supplied to the neutral side, further comprising a phase side being electrically connected to the AC/DC-inverter; a controller, at least configured to selectively operate the AC/DC-inverter and the AC electrical machine system as a voltage boost converter to increase the DC input voltage and supply it to the output port, or as an electric drive system to convert and supply a drive voltage of the energy storage device from the output port to the AC electrical machine system, or to interrupt the electrical connection between the input port and output port via the AC electrical machine system and AC/DC-inverter; and a DC input voltage bypass running from between the neutral side and the switching element via a selective electronic gate to the output port, said gate having a least one operational state with a conducting direction towards the output port and a reverse direction towards the input port;
a charging system according to claim 11.

15. A method of operating a charging system according to claim 13, comprising the following steps:
I) Connection of an external charging device to an input port;
II) Delivery of a DC input voltage to the input port;
III) Detection of a voltage level of the DC input voltage by a controller; and
A) Performing the following actions, if the DC input voltage is at a pre-defined high level:
IV-A) Interruption of an electrical connection between the input port and an output port via an AC electrical machine system and a AC/DC-inverter by the controller;
V-A) Delivery of the DC input voltage to the output port via a DC input voltage bypass in a conducting direction of a selective electronic gate;
VI-A) Charging an energy storage device electrically connected to an output port; or
B) Performing the following actions, if the DC input voltage is at a pre-defined low level:
IV-B) Operation of the AC/DC-inverter and the AC electrical machine system as a voltage boost converter by the controller to increase the DC input voltage;
V-B) Delivery of the increased DC input voltage to the output port via the AC/DC-inverter;
VI-B) Charging the energy storage device electrically connected to the output port.

16. The method according to claim 15, wherein at least one of the following steps is performed:
I-a) implemented in step I, wherein the controller is running a pre-charging mode by interrupting the electrical connection between the input port and the output port via the AC electrical machine system and the AC/DC-inverter, opening a switching element and closing a second switching element and then the DC input voltage is delivered from the plugged-in external charging device to a capacitor;
I-b) implemented in step I or performed prior to step I, wherein the controller is running an alternative pre-charging mode by opening the second switching element, closing the switching element and enabling the electrical connection between the input port and the output port via the AC electrical machine system and the AC/DC-inverter and then a drive voltage is delivered from the energy storage device to the capacitor;
VII) performed after step VI-A or VI-B, wherein the controller is running a discharging mode, by opening the second switching element, closing the switching element and interrupting the electrical connection between the input port and the output port via the AC electrical machine system and the AC/DC-inverter, while connecting a positive side and a negative side of the charging circuit via the AC/DC-inverter and then energy stored in the capacitor dissipates while circulating in an electric loop formed by the capacitor, the switching element, the AC electrical machine system, the AC/DC-inverter and the negative side of the charging circuit.

17. The method according to claim 15, wherein a diode is used in step V-A) to deliver the DC input voltage in the conducting direction to the output port and to prevent backflow of current in the reverse direction to the input port.

18. The method according to claim 15, wherein the charging system forms part of a vehicle and the energy storage device of the vehicle is charged.
